(19) United States
(12) Patent Application Publication
(10) Pub. No.: US 2009/0063257 A1
(43) Pub. Date: Mar. 5, 2009

(54) AUTOMATED PEAK DEMAND CONTROLLER

(75) Inventors: Robert Edwin Zak, Port Orchard, WA (US); Tyler Jon Bergan, Lynnwood, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: POWERIT SOLUTIONS, LLC, Seattle, WA (US)

(21) Appl. No.: 12/201,911

(22) Filed: Aug. 29, 2008

Related U.S. Application Data
(60) Provisional application No. 60/969,487, filed on Aug. 31, 2007.

(51) Int. Cl. G06Q 50/00; G06F 1/28; G06F 1/32; G06Q 10/00

(52) U.S. Cl. 705/10; 700/286; 700/291; 700/295

(57) ABSTRACT

A system and method for managing electrical energy output by a power utility facility are disclosed. The system comprises a computing device associated with a power utility facility that is connected to a computing device operating at a customer facility. The power meters linked to the computing devices provide readings of energy consumption by the customer facility and energy output by the utility. The computing device associated with the utility is configured to control electrical energy output by the power utility facility by predicting a peak energy demand and by requesting the computing device associated with the customer facility to reduce energy consumption when the predicted peak energy demand by the customer facility exceeds a predetermined peak energy consumption setpoint. If the peak energy demand still exceeds the setpoint after the customer reduced its energy consumption, the utility dynamically adjusts the setpoint to match the demand.

### CROSS-REFERENCE TO RELATED APPLICATION

The present application claims the benefit of Provisional Application No. 60/969,487 filed Aug. 31, 2007, which application is incorporated herein by reference in its entirety.

### BACKGROUND

The present invention is in the technical field of electrical energy demand management. More particularly, the present invention is in the technical field of automated peak demand management, wherein an automated energy management system manipulates site loads in order to create a reduction in electrical energy consumption and utility peak-demand based fees associated with the energy consumption.

Power utility companies supply electrical energy to their customers. The power utility customer base includes customers who run facilities with high energy demands, such as plants, workshops, wineries, commercial rental buildings, and so on. In order for the energy supply to match the demand, power utilities rely on extensive use of power generation resources in order to compensate sudden peaks in power demand created by their customers. Such peaks occur, for example, when sudden weather changes require customers to use additional air conditioners or provide more heat to a facility. Power utilities, as a rule, transfer the cost of peak demand to their customers by imposing additional cost when the energy demand created by the customers reaches its peak. In order to accommodate sudden peaks in demand, power utilities have to employ additional power generation resources, thereby increasing capital investments for backup power generation. Therefore, it is important for the utility companies to minimize the peak energy demand, thereby reducing their capital investment and minimizing the additional cost charged to customers

Most power utility facilities charge their customers for the highest peak energy demand reached by a customer during a billing period. The highest peak energy demand thus becomes a basis for the cost of energy charged to a customer for the billing period. Clearly, it is in the utility customers' interests to keep their peak demand as low as possible.

Presently, both power utilities and their customers employ a special technique which helps keep the peak energy demand in check. The technique in question involves using an energy peak demand setpoint, which is a predetermined energy peak demand limit. The technique involves staging or scheduling loads to shut down at a time when the present usage is predicted to exceed the setpoint. Thus, reaching a predetermined energy peak demand setpoint by an energy supply or energy consumption system triggers a savings action by that system.

While a value of a setpoint is usually determined based on the statistical data characterizing the energy demand for a particular time period, in many cases this setpoint is set unnecessarily high due to a utility operator's hesitancy or inattentiveness. Setting a higher than needed setpoint value results in lower cost savings. Also, when customers' peak charges are linked to their utility's actual peaks, sometimes a utility provides to their customers estimates as to the time when peak demand will occur. This estimate from the utility is often an erroneous prediction of an actual peak timing, which causes either non-action during an actual peak or unnecessary action during a time that did not become the utility's peak for that month.

Therefore, a system and method are needed that would provide efficient management of energy peak demands so that the energy costs to both the utility and its customers are minimized.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The primary purpose of the present invention is to minimize peak energy demand, thereby reducing the capital investment for backup power generation by a power utility. The system and method are described that manage electrical energy output by a power utility facility by automatically determining and setting the most efficient peak demand setpoint and managing power loads in accordance with the predetermined setpoint.

The system comprises a computing device associated with a power utility facility that is connected to a computing device associated with a customer facility. The computing device associated with the utility is configured to control electrical energy output by the power utility facility by monitoring energy demand and by requesting the computing device associated with the customer facility to reduce energy consumption when the energy demand by the customer facility exceeds a predetermined peak energy consumption setpoint. The power meters linked to the computing devices provide readings of energy consumption by the customer facility and energy output by the utility.

In one embodiment, the utility associated computing device is a microcontroller running a software that monitors the utility's present power consumption. The microcontroller performs analysis to determine if it needs to communicate to a microcontroller associated with the utility's customer facility and instruct the customer facility to take action to reduce the power consumption. This in turn reduces the utility's energy consumption or makes energy available for more critical needs.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary control system for managing electrical power consumption by a power utility facility;

FIG. 2 is a diagram illustrating an exemplary timing scale of a billing period divided into debit periods, each debit period further divided into subintervals;

FIG. 3 is a flow diagram illustrating an exemplary routine for managing electrical power consumption by a power utility facility during a billing period;

FIG. 4 is a flow diagram illustrating an exemplary routine for a peak energy demand prediction algorithm;

FIG. 5 is a flow diagram illustrating an exemplary subroutine for an adaptive setpoint algorithm; and

FIGS. 6A-6B are flow diagrams illustrating an exemplary routine for managing electric loads at a customer facility during a billing period.

### DETAILED DESCRIPTION

While illustrative embodiments have been illustrated and described, it will be appreciated that various changes can be made therein without departing from the spirit and scope of the invention.

The system and method of the present invention will utilize algorithms working in conjunction with each other, a utility energy peak demand prediction algorithm and adaptive setpoint algorithm, to minimize peak energy demand by end users, whereby reducing the costs associated with energy utilization and optimizing the utilization of the existing power generation resources. There could be an unlimited number of end user (customer) facilities depending on the number of end users the utility chooses to link to the integrated demand control system. Both algorithms function within a particular time frame, namely, a utility billing period, which is divided into several debit periods, each of which is further divided into subintervals.

A computing device associated with the utility entity, such as, for example, a controller, would monitor and predict the utility's demand. It will receive information or signals from the utility meter relating to its overall load. The demand would be predicted by accumulating the total kWh (kilo watt hours) over a predetermined period of time, or subinterval. The demand is then calculated by converting this value into an average kW value for this predetermined period of time. The demand for the subinterval is predicted by extrapolating the kWh consumption to the end of the subinterval. If the utility controller predicts that the utility may exceed the predetermined demand setpoint, the controller will send a request to the computing devices, such as controllers, associated with the end user facilities. The request from the utility controller will trigger the end user controller(s) to reduce demand, having a subsequent impact of reducing demand at the utility meter. Once the utility request is fulfilled, the end user controller will go into a “normal” mode of operation, where it no longer seeks to reduce demand and allows the end user site to operate in its regular energy consumption regime. This ensures that the end user(s) will only be in the energy peak demand control mode during the intervals in which utility will possibly experience a peak demand for the month. Then the system will act to reduce the end user(s) demand during intervals in which the utility will likely experience a peak for the month. The above technique allows the utility and its customers to maximize system savings while not affecting monthly production.

The adaptive setpoint algorithm automatically adjusts the peak energy demand (or consumption) setpoint to the highest energy utilization of the billing period. As described in the Background section, the peak demand setpoint is usually set very high so the utility is not constantly interrupting the customer operation to manage the peak power. An automatic adjustment of the setpoint eliminates this deficiency.

At the beginning of the billing period, the setpoint can be set very low. If the peak prediction algorithm detects the utility peak demand will exceed the setpoint for the present debit period, it will request the customers reduce their energy utilization. After the debit period is complete, the adaptive setpoint algorithm determines if the debit period energy (kWh) exceeded the setpoint. If the setpoint was exceeded, the setpoint will be adjusted up to match the debit period kWh. From this point on, the rest of the billing period will be managed at this new setpoint. This process can happen many times in the billing period. As a result, the system quickly and automatically adjusts to a reasonable setpoint. At the beginning of a new billing period, the setpoint is reset to its beginning value.

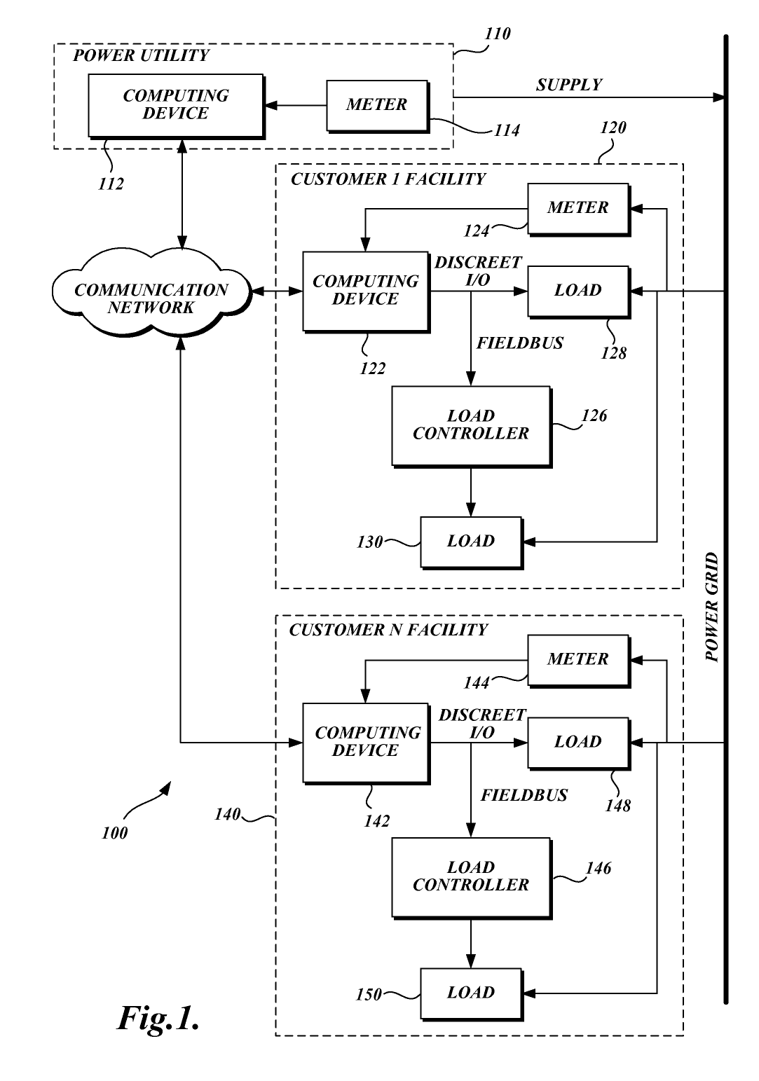

FIG. 1 is a block diagram illustrating an exemplary system 100 for managing electrical energy consumption by a power utility facility. For ease of illustration and description, only the major components of the system are illustrated. Those skilled in the art will recognize that these major components should be viewed as illustrative only and not construed as limiting in any manner.

The system 100 comprises a power utility facility 110 and its customer 120. The power utility facility 110 supplies electrical energy to its customer 120 through a power grid. A power utility facility houses a computing device 112 linked to a power meter 114, also associated with the power utility facility 110. The power meter 114 accumulates customer energy consumption data and communicates it to the computing device 112. There are different ways to provide energy consumption data. In one embodiment, it may come directly from the customers' facilities. In another embodiment, a separate computer system (not shown) may be configured to accumulate customer energy consumption data and present them in a form of a real-time data list accessible by a computing device.

The computing device 112 is connected through a communication network 170 with a computing device 122, which is associated with the customer facility 120. The computing device 122 is connected to a power meter 124 and to electric loads 128 and 130 associated with the customer facility 120. The power meter 124 provides readings of a customer facility energy consumption to the computing device 122.

The computing device 122 may be connected to customer facility's loads 128 through a digital input-output interface. Alternatively, the computing device 122 may be connected to the customer facility's loads 130 through a field bus and a load controller 126. Those skilled in the art will recognize that there are different ways of connecting a computing device associated with a customer facility with the facility's electric loads. The connection between a computing device associated with the customer facility and the customer facility electric loads is needed, among other things, for facilitating load reduction actions, as described below in more detail.

Those skilled in the art also will appreciate that the system 100 may include more than one customer facility that is connected with the power utility 110 and that there are different ways of connecting computing devices associated with a power utility with computers associated with customer's facilities. By way of example, a second customer facility 140 is shown in FIG. 1. The computing device 142 associated with the customer facility 140 is connected with the computing device 112 of the utility 120 through the communication network 170. A computer connection through the network 170 is not limiting in any manner and is shown for illustrative purposes only; there may be other ways of connecting computers known to those skilled in the art. The computing device 142 is connected to a meter 144 and to electric loads 148 and 150 associated with the customer facility 140. For illustration only, load 148 is connected to the computing device 142 through a discreet input/output interface, whereas load 150 is connected to a computing device 142 through a load controller 146.

The computing devices 112, 122, and 142 may be computers of any type having a processor, a system memory and a system bus that couples various computer components, including memory, to the processor. The computing devices 112, 122, and 142 typically include a variety of computer-readable media. Computer-readable media can be any available media that can be accessed by a computing device and include both volatile and nonvolatile media and removable and nonremovable media. By way of example, and not limitation, computer-readable media may comprise computer storage media and communication media. Computer storage media include both volatile and nonvolatile and removable and nonremovable media implemented in any method or technology for storage and information, such as computer-readable instructions, data structures, program modules, or other data. Computer storage media include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium that can be used to store the desired information and that can be accessed by a computing device. Communication media typically embody computer-readable instructions, data structures, program modules, or other data in the modulated data signal, such as a carrier wave or other transport mechanism, and include any information delivery media. The system memory typically includes computer storage media in the form of volatile and/or nonvolatile memory, such as read-only memory (ROM) and random-access memory (RAM). The computing devices 112, 122, and 142 may also include other removable/nonremovable, volatile/nonvolatile computer storage media. In one embodiment, computing devices 112, 122, and 142 may be microcontrollers configured to perform the method of the present invention as described below.

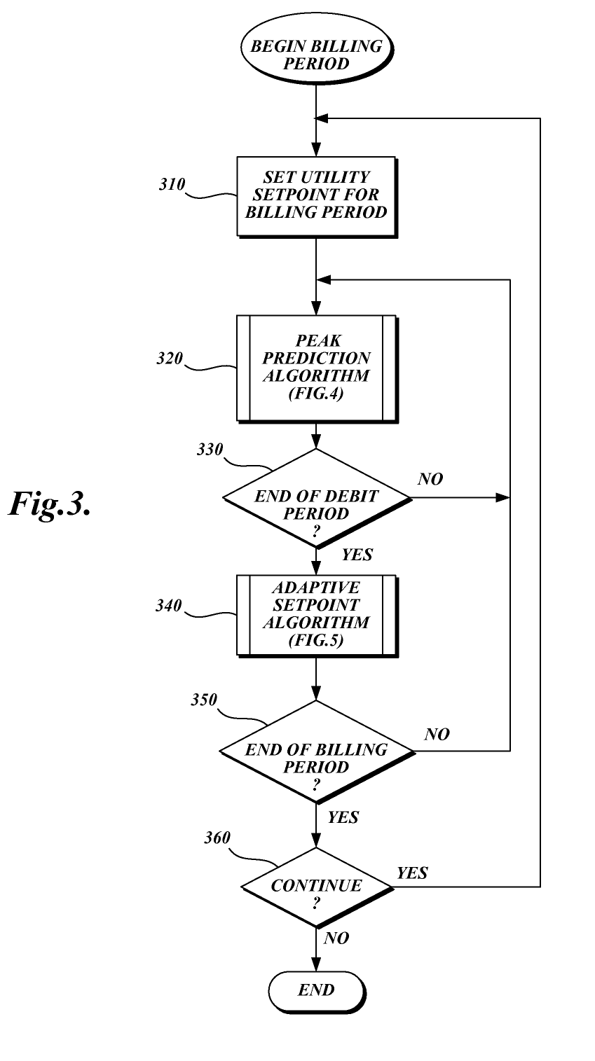

As indicated above, the system illustrated in FIG. 1 functions within particular timing parameters, such as a billing period, debit period, and subinterval. A billing period is a time period of electrical energy consumption, for which a customer of a power utility is billed by the utility that provides the electrical energy to the customer. For the purposes of the method described below and illustrated in FIGS. 3-6, a billing period is further divided into debit periods, and each debit period is divided into subintervals. The utility uses debit periods to determine each customer's peak energy usage (kWh). The utility will measure the energy used for each debit period during the billing period. The debit period that has the most energy consumption (highest kWh) is the peak energy period for the billing period. The utility will charge the customer based on the peak energy period.

Typically, the billing period is defined by the utility and may comprise, for example, one month. A debit period comprises any time period suitable for the method of FIGS. 3-6, such as 15, 30, or 60 minutes, for example. The debit period is divided into one or more subintervals depending on the length of the debit period. Although the length and exact number of debit periods and subintervals may vary, in one embodiment each debit period is divided into fifteen subintervals.

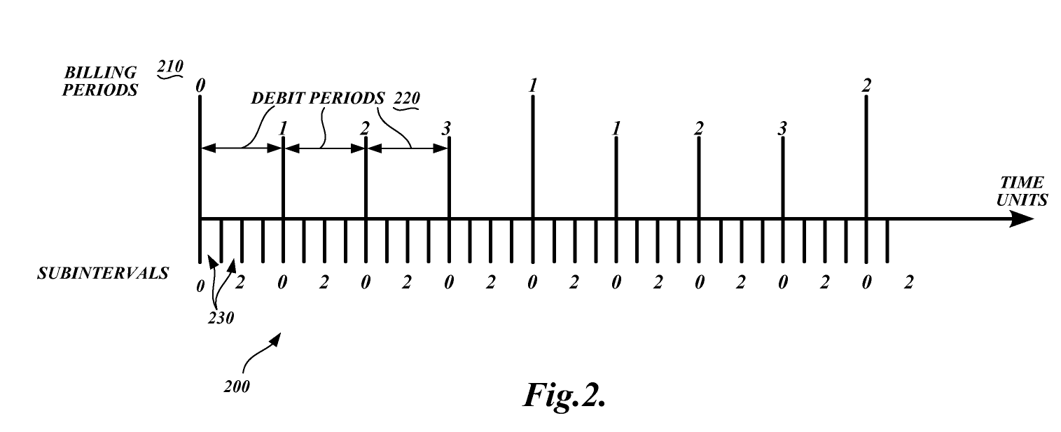

FIG. 2 illustrates an exemplary timing scale 200 of billing periods 210 divided into debit periods 220, each debit period is further divided into subintervals 230. Billing periods 210, debit periods 220, and subintervals 230 are represented by time units along the X axis. For illustrative purposes, the diagram shows two billing periods, the first billing period beginning with a number 0 and ending with a number 1, the second billing period beginning with digit 1 and ending with digit 2, each digit representing a number of billing periods. By way of example, each billing period is divided into four debit periods as shown in the diagram 200, and each debit period 220 is further divided into subintervals. For illustrative purposes only, each debit period is divided into four subintervals.

FIG. 3 illustrates an exemplary computer-implemented method of managing electrical energy consumption by a power utility facility during a billing period. The method begins by starting a present billing period. Next, at block 310, a peak power consumption setpoint for the billing period is set to a predetermined value. At block 320, the process begins the peak prediction subroutine further illustrated in FIG. 4 and described below in detail. Briefly, at block 320 it is determined, for each subinterval, whether energy consumption for the present debit period will exceed a predetermined peak energy demand setpoint and action is taken to reduce the demand (by reducing electric loads) if such action is needed. Once such determination is made and a load reduction action, if any, is taken, the subroutine returns and the process moves to block 330.

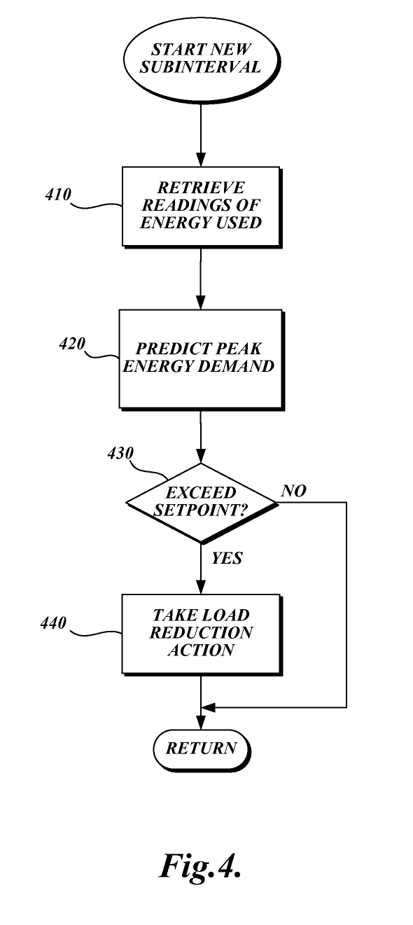

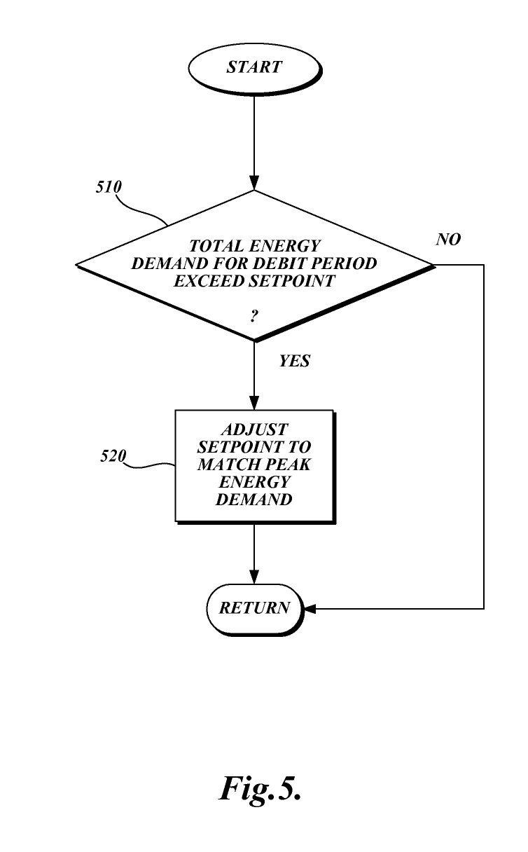

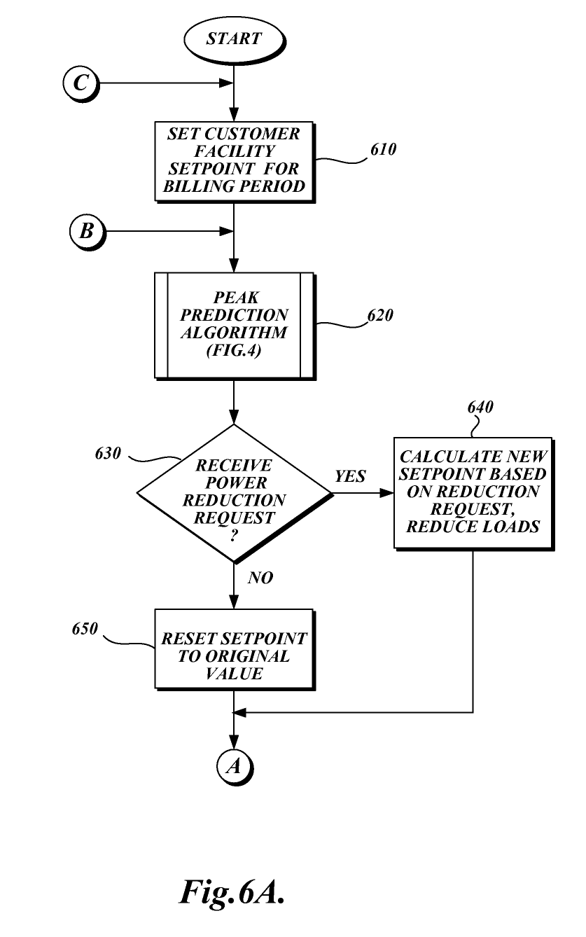

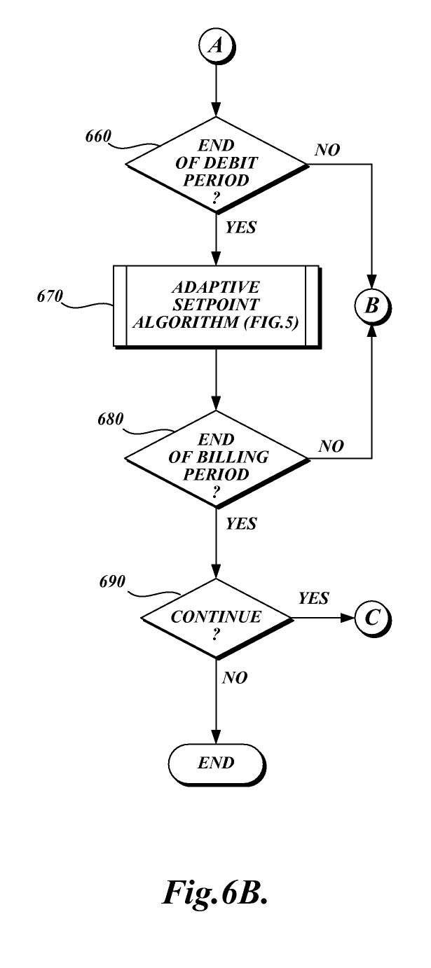

At block 330, a test is made to determine if an end of a debit period has been reached. If the end of a debit period has not been reached, the process loops back to block 320. If the debit period has ended, the process moves to block 340 where an adaptive setpoint subroutine begins. The adaptive setpoint subroutine is illustrated in FIG. 5 and will be described in more detail below. Briefly, at block 340 it is determined whether the debit period energy exceeded the predetermined setpoint, and if so, the setpoint is adjusted to match the debit period energy.

Upon completion of block 340 subroutine, it is determined at block 350 if the end of the billing period has been reached. If the end of the billing period has not been reached, the process loops back to the peak prediction subroutine of block 320. If, however, the billing period has ended, the process moves to the next test at block 360 where the determination is made as to whether the process should continue. If the test is passed, the process loops back to block 310, where a new setpoint for the next billing period is set at a predetermined value. If the test at block 360 is not passed, the process illustrated in FIG. 3 ends.

FIG. 4 is a flow diagram illustrating an exemplary energy peak demand prediction subroutine. The subroutine starts by beginning a new subinterval. At block 410, the readings of the energy used by the facility are retrieved. At block 420, the calculation of a predicted peak energy demand for the facility is made based on the readings of present energy consumption by the facility. The goal is to predict if energy consumption for the present debit period will exceed a setpoint and take action to reduce just enough energy consumption to prevent exceeding the setpoint and creating an undesirable peak demand. One exemplary method of such calculation is described below.

As described above in relation to FIG. 2, each debit period is divided into subintervals. At the beginning of the debit period, energy utilization (kWh) is set to zero. The computing device monitors the utility power meter for energy utilization (kWh). The debit period is then divided into a number of subintervals used to calculate power (rate of energy utilization kW). Some of the key parameters for this calculation are defined as follows:

kWhChange is the energy used in the subinterval expressed in kWh;

kWhChange=(kWh at the end of the subinterval)−(kWh at the beginning of the subinterval) SubintervalPeriod is the duration of the subinterval, usually expressed in hours;

SubintervalPeriod=(DebitPeriod/60)/# Subintervals;

kWPresent=(kWhChange/SubintervalPeriod); kWPresent (kW) is the present power.

DebitPeriod (minutes)=time interval to analyze peak energy utilization. This value is typically 15, 30 or 60 minutes.

# Subintervals (integer)=number of subintervals within the DebitPeriod that is used to calculate power.

kWhLimit (kWh) is the peak energy consumption setpoint. The algorithm will attempt to keep energy consumption for the DebitPeriod below this value.

kWhUtilized (kWh) is the energy used since beginning of DebitPeriod as measured from the power meter.

kWhRemaining (kWh)=kWhLimit−kWhUtilized

secondsElapse (seconds)=time in seconds since beginning of present DebitPeriod

secRemaining (seconds)=DebitPeriod*60−secondsElapse

The following calculations are performed at the end of each subinterval.

First, the maximum power is calculated that would create energy utilization (kWhUtilized) equal to the setpoint (kWhLimit). Then the present power is compared to the maximum power calculated to determine if action needs to be taken.

kWLimitAverage=(kWhRemaining*3600)/secRemaining

The kWLimitAverage is adjusted based on how early in the DebitPeriod the calculation is made. Each subinterval has a configurable % multiplier that is applied to kWLimitAverage to create kWLimitAdjusted.

kWLimitAdjusted=kWLimitAverage*limitAdjn where limitAdjn (limitAdj1, limitAdj2 . . . ) is the adjustment parameter for the present subinterval expressed in %.

Finally, the required change to kW (kWChange) is calculated to assure the kWh for the period does not exceed kWhLimit.

kWChange=kWLimitAdjusted−kWPresent

If kWChange is negative, the computing device needs to take a load reduction action to reduce kWh, as described below with respect to blocks 430 and 440.

The above calculation is but one example of how an energy peak can be predicted. Those skilled in the art will recognize that there may be other ways of making such calculation.

At block 430, the test is made to determine whether the predicted peak power demand exceeds the peak power consumption setpoint, and if this test is passed, i.e., if the algorithm has determined that energy utilization must be reduced, the load reduction action is taken at block 440, after which the subroutine returns.

The load reduction action undertaken at block 440 comprises the communication of the request to reduce the customer's electrical loads from the computing device associated with the utility to the computing device associated with the customer facility. The communication may occur over any standard communication network such as the Internet. The communication will typically include a specific reduction request in kWh. In one embodiment, the customer loads may be modeled at the utility computing device and, based on the modeled loads, discreet amounts of energy by which each customer needs to reduce its consumption may be calculated and included in the reduction request. The actual reduction value is determined by each customer load configuration and total kWh reduction required. Those skilled in the art will recognize that there are different ways of calculating specific reduction requests that are communicated to utility customers.

The customer's computing device will use this reduction request and attempt to manage its loads to meet the request. The algorithms for managing customer loads are well known to those skilled in the art and will not be described herein.

FIG. 5 is a flow diagram illustrating an exemplary subroutine for an adaptive setpoint algorithm. At block 520, the test is made to determine whether total energy demand for the debit period exceeds the predetermined setpoint. If this is the case, the setpoint gets adjusted to match the peak energy demand at block 520, and the subroutine returns. If the total energy demand remains below the setpoint, the adjustment is not needed and the subroutine returns.

FIGS. 6A-6B illustrate an exemplary routine for managing electric loads at a customer facility during a billing period. It is important to note that the customer utility may, although does not have to, employ essentially the same peak prediction and adaptive setpoint algorithms in managing their electric loads as a power utility. Those skilled in the art will appreciate that other algorithms of managing customer electric loads may be realized.

A peak energy consumption setpoint for the billing period is set to a predetermined value at block 610. The process then moves to a peak prediction algorithm at block 620 illustrated in detail in FIG. 4. The peak prediction algorithm as applied to a customer facility operates essentially the same as in the case of its application to a utility (see FIG. 3), with a few differences. For the customer facility, the algorithm employs different setpoint values for its “normal” mode of operation and for the instance when a reduction request from the utility has been received (block 630). The algorithm also provides for direct control of electric loads in order to reduce energy utilization when appropriate.

The algorithm uses a predetermined setpoint for customer utility's “normal” mode of operation (Setpoint1), whereby the customer facility's computing device will monitor the facility power meter and manage the peak power demand to this setpoint (block 620 and FIG. 4).

The load reduction action of block 440 of FIG. 4, when the algorithm is applied to a customer facility, functions in a different manner than the utility's load reduction action. The customer's load reduction action provides the actual reduction of the customer's loads by utilizing known load reduction algorithms not described herein. Briefly, each piece of equipment connected to the controller is a load that can be reduced as required. The load reduction algorithm is programmed to “know” the size of each load and set priorities as to which load to reduce first. The actual reduction action is determined by the customer load configuration and total kWh reduction required. As described above with respect to FIG. 4, the peak prediction algorithm operates during each subinterval.

At the end of a subinterval, when the subroutine of block 620 returns, the test is made at block 630 to determine whether a power reduction request from the power utility facility has been received. If such request has been received, the new setpoint based on the received reduction request is calculated at block 640. This new, usually lower, setpoint will be used when the utility's computing device has requested system power reduction for a customer facility. This setpoint will vary based on amount of kWh reduction being requested by the utility (kWhReductionRequest). This new setpoint may be calculated as follows:

Setpoint2=Setpoint1−kWhReductionRequest

The customer's computing device will connect directly to electric loads or indirectly through common field buses to reduce energy utilization when determined by the peak prediction algorithm based on the new setpoint value.

Once the power reduction request is removed, the setpoint is reset to its original value at block 650.

Block 660 provides a test to determine if the end of the debit period has been reached. If the debit period has ended, the process moves to the subroutine of block 670, an adaptive setpoint algorithm, illustrated in FIG. 5 and described above in detail. If the end of the debit period has not been reached, the process returns to block 620. When the subroutine of block 670 returns, the test is made at block 680 to determine whether the end of the billing period has been reached. If this has not occurred, the process returns to the peak prediction algorithm subroutine at block 620 described above. If, however, the billing period has ended, another test is made at block 690 to determine whether to continue with the process. If the decision is made to continue, the process returns to block 610 where a new customer facility setpoint is set for the new billing period. If the decision has been made to stop the process, the routine ends.

While illustrative embodiments have been illustrated and described, it will be appreciated that various changes can be made therein without departing from the spirit and scope of the invention.

The embodiments of the invention in which an exclusive property or privilege is claimed are defined as follows:

1. A control system for managing electrical energy output by a power utility facility to a customer facility, the system comprising:
a first computing device configured to control electrical energy output by the power utility facility by monitoring energy demand and by requesting the customer facility to reduce energy consumption when the energy demand by the customer facility exceeds a predetermined peak energy consumption setpoint;
a first power meter communicatively coupled to the first computing device, the first power meter configured to measure energy consumption by the power utility facility and to communicate measured energy consumption to the first computing device;
a second computing device connected to the first computing device, the second computing device configured to manage energy consumption by the customer facility and to communicate with the first computing device; and
a second power meter communicatively coupled to the second computing device, the second power meter configured to measure energy consumption by the customer facility and to communicate measured energy consumption to the second computing device.

2. The control system of claim 1, wherein the first computing device is a controller associated with the power utility facility.

3. The control system of claim 1, wherein the second computing device is a controller associated with the customer facility.

4. The control system of claim 1, wherein the first computing device is connected to the second computing device through a communication network.

5. The control system of claim 1, wherein the first computing device is further configured to predict a peak energy demand and adjust the predetermined peak energy consumption setpoint in accordance with the predicted peak energy demand.

6. The control system of claim 1, wherein a request to the customer facility to reduce energy consumption is communicated to the second computing device.

7. The control system of claim 1, wherein managing energy consumption by the customer facility includes responding to a request to reduce energy consumption by reducing electric loads at the customer facility in accordance to the request.

8. A computer-implemented method of managing electrical energy output by a power utility facility during a billing period, the method comprising:
setting a peak energy consumption setpoint for the billing period to a predetermined value;
predicting peak energy demand for the power utility facility based on the readings of a present energy output; and
if the predicted peak energy demand exceeds the peak energy consumption setpoint, requesting a customer facility to reduce energy consumption.

9. The computer-implemented method of claim 8, wherein the billing period is divided into debit periods, each debit period being divided into subintervals.

10. The computer-implemented method of claim 9, wherein predicting peak energy demand for the power utility facility occurs each subinterval.

11. The computer-implemented method of claim 9, further comprising:
at the end of each debit period, adjusting the peak energy consumption setpoint to match the predicted peak energy demand if the predicted peak power demand exceeds the peak energy consumption setpoint.

12. The computer-implemented method of claim 10, wherein the readings of a present energy output by the power utility correspond to energy consumption readings provided by customer facilities.

13. A computer-implemented method of managing electric loads at a customer facility during a billing period, the method comprising:
setting a peak energy consumption setpoint for the billing period to a predetermined value;
predicting a peak energy demand for the customer facility based on readings of a present energy consumption by the customer facility;
if the predicted peak energy demand exceeds the peak energy consumption setpoint, reducing electric load at the customer facility; and
in response to a request to reduce energy consumption communicated by a power utility facility, adjusting the peak energy consumption setpoint in accordance with the request and reducing electric load in accordance with the adjusted peak energy consumption setpoint.

14. The computer-implemented method of claim 13, wherein the billing period is divided into debit periods, each debit period being divided into subintervals.

15. The computer-implemented method of claim 14, further comprising resetting the peak energy consumption setpoint to the predetermined value at the end of each subinterval in the absence of the request to reduce energy consumption communicated by a power utility facility.

16. The computer-implemented method of claim 14, wherein predicting peak energy demand for the customer facility occurs during each subinterval.

17. The computer-implemented method of claim 14, further comprising adjusting the peak energy consumption setpoint to match the predicted peak energy demand at the end of each debit period if the predicted peak energy demand exceeds the peak energy consumption setpoint.

18. A computer readable storage medium having computer-executable instructions, which, when executed on a processor:
set a peak energy consumption setpoint for a billing period to a predetermined value;
predict peak energy demand for the power utility facility based on the readings of a present energy output; and
if the predicted peak energy demand exceeds the peak energy consumption setpoint, request a customer facility to reduce energy consumption.

19. The computer readable storage medium of claim 18, wherein the billing period is divided into debit periods, each debit period being divided into subintervals.

20. The computer readable storage medium of claim 19, wherein predicting peak energy demand for the power utility facility occurs each subinterval.

21. The computer readable storage medium of claim 19, wherein the computer-executable instructions, when executed on the processor:
at the end of each debit period, adjust the peak energy consumption setpoint to match the predicted peak energy demand if the predicted peak power demand exceeds the peak energy consumption setpoint.

22. The computer readable storage medium of claim 19, wherein the readings of a present energy output by the power utility correspond to energy consumption readings provided by customer facilities.

23. A computer readable storage medium having computer-executable instructions, which, when executed on a processor:
set a peak energy consumption setpoint for a billing period to a predetermined value;
predict peak energy demand for the customer facility based on readings of a present energy consumption by the customer facility;
if the predicted peak energy demand exceeds the peak energy consumption setpoint, reducing electric load at the customer facility; and
in response to a request to reduce energy consumption communicated by a power utility facility, adjusting the peak energy consumption setpoint in accordance with the request and reducing electric load in accordance with the adjusted peak energy consumption setpoint.

24. The computer readable storage medium of claim 23, wherein the billing period is divided into debit periods, each debit period being divided into subintervals.

25. The computer readable storage medium of claim 24, wherein the computer executable instructions, when executed on the processor, reset the peak energy consumption setpoint to the predetermined value at the end of each subinterval in the absence of the request to reduce energy consumption communicated by a power utility facility.

26. The computer readable storage medium of claim 24, wherein predicting peak energy demand for the power utility facility occurs each subinterval.

27. The computer readable storage medium of claim 24, wherein the computer executable instructions, when executed on the processor, adjust the peak energy consumption setpoint to match the predicted peak energy demand at the end of each debit period if the predicted peak energy demand exceeds the peak energy consumption setpoint.
